(19) United States
(12) Patent Application Publication
(10) Pub. No.: US 2008/0010132 A1
(43) Pub. Date: Jan. 10, 2008

(54) Methods, systems, and computer program products for targeting advertising to customers of content service providers

(76) Inventors: Jeffrey A. Aaron, Atlanta, GA (US); Thomas A. Anschutz, Atlanta, GA (US)

Correspondence Address: MYERS BIGEL SIBLEY & SAJOVEC, P.A., P.O. BOX 37428, RALEIGH, NC, 27627, US

(21) Appl. No.: 11/454,417

(22) Filed: Jun. 16, 2006

(51) Int. Cl. G06Q 30/00

(52) U.S. Cl. 705/14

(57) ABSTRACT

Methods, systems and computer program products for targeting advertising to customers requesting content from a service provider are provided. Upon receiving a request for content from a customer of a service provider, advertising to be delivered with the requested content is selected. The requested content and selected advertising are delivered to the customer and feedback is obtained from the customer regarding the selected advertising. A customer preference knowledge base is built/maintained for use in selecting advertising to be delivered with subsequently requested content.

### FIELD OF THE INVENTION

The present invention relates to communications networks, and, more particularly, to methods, systems, and computer program products for providing advertising via communications networks.

### BACKGROUND OF THE INVENTION

Communications networks are widely used for nationwide and worldwide communication of voice, multimedia and/or data. As used herein, the term “communications networks” includes public communications networks, such as the Public Switched Telephone Network (PSTN), terrestrial and/or satellite cellular networks, private networks and/or the Internet.

The Internet is a decentralized network of computers that can communicate with one another via Internet Protocol (IP). The Internet includes the World Wide Web (WWW) service facility, which is a client/server-based facility that includes a large number of servers (computers connected to the Internet) on which Web pages or files reside, as well as clients (Web browsers), which interface users with the Web pages. The topology of the World Wide Web can be described as a network of networks, with providers of network services called Network Service Providers, or NSPs. Servers that provide application-layer services may be referred to as Application Service Providers (ASPs). Sometimes a single service provider provides both functions.

Television networks include both traditional broadcast networks as well as cable and satellite television networks. The combination of the Internet, wireless/wireline telecommunication networks, television networks, and the like may provide a user with many sources for content.

Referring to FIG. 1, a demand curve 10 representative of the demand for goods/services of virtually any industry, is illustrated. The portion of the curve designated as “H” indicates products/services referred to as “head-of-tail” products/services i.e., products/services which traditionally have dominated industry sales. For example, in the music and book industries, head-of-tail sales are traditionally known as “hits” or “best sellers.” The part of the demand curve 10 designated as “LT” indicates products/services know as “long tail” products/services. Long tail products/services are the non-hits, or niches, which is where many marketers believe new growth is coming from for many industries. For example, conventional retail stores typically only stock the likely hits, because of the finite amount of shelf space, and because shelf space is expensive. However, online retailers (e.g., Amazon, Apple Computer's iTunes, etc.) can stock virtually everything (head-of-tail and long tail) since storage is not an issue. In virtually every industry, the number of available niche products/services (i.e., long tail products/services) may outnumber the hits by several orders of magnitude.

With respect to on-line content (e.g., audio content, video content, etc.) there are many niches of long tail content that have been largely neglected by traditional content suppliers. Marketers have recently discovered that there is tremendous demand for long tail content and that demand is less hit-centric than previously thought. As a result, on-line content providers are increasingly searching for ways of exploiting long tail content. Moreover, on-line content providers are searching for ways of maximizing revenue from the exploitation of long tail content.

In advertising and marketing, it may be desirable to target advertisements to the appropriate potential customer base, rather than to broadcast advertisements in general. For example, it may be ineffective for advertisements for computers to appear in gardening magazines, and advertisements for gardening tools may not be effective in computer magazines.

Targeted advertising has also made its presence in broadcast television environments. For example, attempts have been made to match the television advertisements to users. One known system uses geographic information to attempt to segment customer lifestyles into identifiable characteristics. In such a lifestyle segmentation system, a database may correlate geography (e.g., zip code) versus predetermined empirical demographic profiles (e.g., household income, age, etc.).

Implementation of interactive television services, such as digital cable and satellite television services which may feature on-demand content, has permitted advertisers to explore new methods for providing targeted advertisements to customers. For example, customer viewing habits and choices may be monitored to establish viewing preferences and purchasing habits. More particularly, click-stream data (based on channel selection entries via a remote control) may be used to monitor tune-in behavior, how much time was spent viewing a particular advertisement, and/or what action was taken after the advertisement was viewed. Such information may be used to tailor advertising of particular products and/or services to individual customers.

Although conventional advertising systems may be able to monitor customer viewing habits associated with a particular account and/or location, they may not be able to obtain feedback from customers regarding particular advertising. In addition, on-line content providers have discovered that digital content delivery technologies, such as TiVo® service, allow customers to skip over advertisements delivered with content. As such, on-line content providers are increasingly searching for ways of providing advertising to customers that customers will be willing to view.

### SUMMARY OF THE INVENTION

According to some embodiments of the present invention, a method of targeting advertising to customers requesting content from a service provider includes receiving a request for content from a customer; selecting advertising to be delivered with the requested content; delivering the requested content and selected advertising to the customer; obtaining feedback from the customer regarding the selected advertising; and building a customer preference knowledge base for use in selecting advertising to be delivered with subsequently requested content.

According to some embodiments of the present invention, selecting advertising to be delivered with the requested content comprises selecting advertising based upon information about the customer.

According to some embodiments of the present invention, selecting advertising to be delivered with the requested content comprises selecting advertising based upon advertising preferences of the customer.

According to some embodiments of the present invention, selecting advertising to be delivered with the requested content comprises selecting advertising based upon advertising preferences of other customers that are similar to the customer.

According to some embodiments of the present invention, selecting advertising to be delivered with the requested content comprises identifying a customer group that the customer is a member of and selecting advertising targeted to the identified customer group.

According to some embodiments of the present invention, selecting advertising to be delivered with the requested content comprises determining a position of the requested content on a content demand curve, wherein the content demand curve is divided into a plurality of discrete content groups, wherein advertising is associated with each content group, and selecting advertising that is associated with a content group at the position of the requested content on the content demand curve.

According to some embodiments of the present invention, obtaining feedback from customers comprises allowing customers to request delivery of alternative advertising. Obtaining feedback may also include allowing customers to indicate whether they like or dislike delivered advertising and/or if they would prefer another type of advertising (e.g., text advertising, video advertising, audio advertising, etc.). Advertising type may also include advertising category (e.g., sports-related advertising, book-related advertising, toothpaste-related advertising, etc.).

According to some embodiments of the present invention, a method of targeting advertising to customers requesting content from a service provider includes receiving a request for content from a customer; receiving a request for content from a customer; selecting advertising to be delivered with the requested content; delivering the requested content and selected advertising to the customer; and obtaining feedback from the customer regarding the selected advertising, including allowing the customer to request delivery of alternative advertising.

According to some embodiments of the present invention, a system for targeting advertising to customers requesting content from a service provider, comprises a server that receives a request for content from a customer; an ad selector that selects advertising (e.g., from an ad database and/or third party provider) to be delivered with the requested content; a feedback collector that obtains feedback from the customer regarding the selected advertising; and a customer preference knowledgebase in communication with the feedback collector and ad selector for use in selecting advertising to be delivered with subsequently requested content. The server is configured to deliver the requested content and selected advertising to the customer.

According to some embodiments of the present invention, the ad selector is configured to select advertising based upon one or more of the following: information about the customer, advertising preferences of the customer, and/or advertising preferences of other customers that are similar to the customer. The ad selector may also be configured to utilize content-related information, such as the content's position on a content demand curve, to select advertising.

Although described primarily above with respect to method and system aspects of the present invention, it will be understood that the present invention may also be embodied as computer program products.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate key embodiments of the present invention. The drawings and description together serve to fully explain the invention.

FIG. 1 is a demand curve that illustrates long tail content and head-of-tail content.

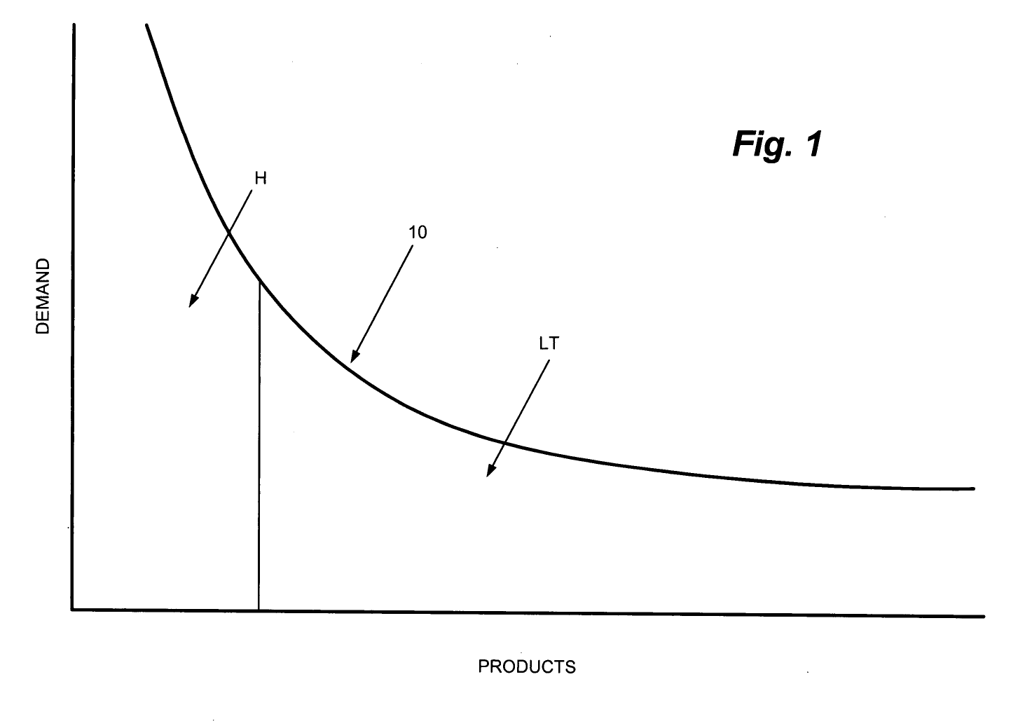

FIG. 2 is a flow chart that illustrates exemplary operations for targeting advertising to customers, according to embodiments of the present invention.

FIG. 3 is a demand curve that illustrates the association of advertising with long tail content and head-of-tail content, according to some embodiments of the present invention.

FIG. 4 is a block diagram that illustrates a software/hardware architecture for targeting advertising to customers, according to some embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “content” means any type of audio content, video content, audio/video content, text, gaming content, interactive content, application content, etc., that can be delivered via a communications network. For example, content may include television programs, movies, voice messages, music and other audio files, electronic mail/messages, World Wide Web (WWW) pages, interactive games, educational material, software applications, etc.

Computer program code for carrying out operations of data processing systems discussed herein may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for delivering content and for associating and applying business models therewith, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

As used herein, the term “advertising” refers to any type of promotion of a product or service.

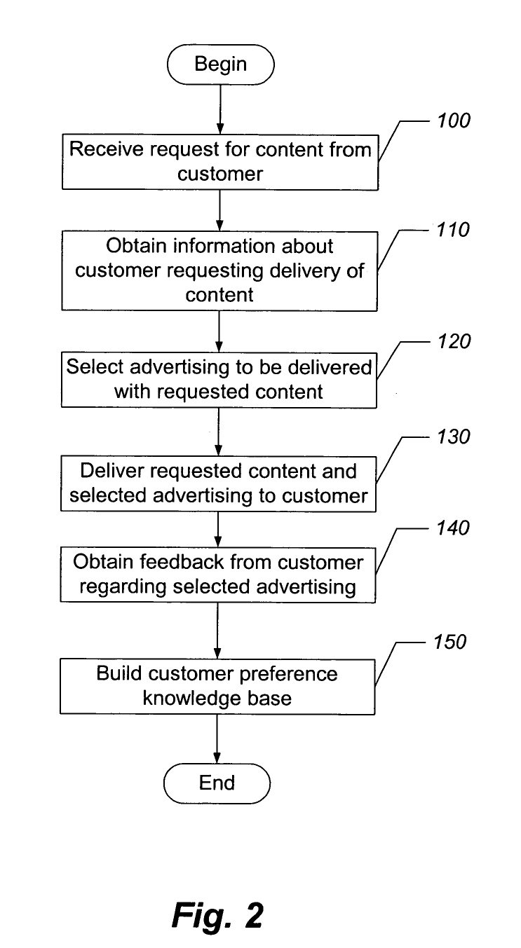

Exemplary operations for targeting advertising to customers requesting content from a service provider, according to embodiments of the present invention, will now be described with reference to FIG. 2. Operations begin at (Block 100) where a request for content from a customer is received by a service provider. The customer request may be generated in whole or in part from any of various customer devices including, but not limited to, television set top boxes, personal computers, wireless communications devices, etc. Moreover, customer requests may be received via a web site of the service provider. Requested content may include any type of audio content, video content, text content, gaming content, interactive content, and/or application content, etc.

Information about the customer making the content request may be obtained (Block 110), and this may occur in various ways. For example, the requesting customer may be required to provide information, for example, via a web site, via e-mail, etc. Information about the requesting customer may be retrieved from various sources, as well, such as customer information databases, public records databases and sources, etc.

Advertising is then selected to be delivered with the requested content (Block 120). Advertising may be selected in various ways. For example, according to some embodiments of the present invention, advertising may be selected based upon information about the customer. This may include information obtained from the customer (or from a third party) and/or information already known about the customer. Exemplary information includes, but is not limited to, information such as the customer's likes and dislikes (e.g., the customer is a sports fan, the customer does not like opera, etc.), the customer's habits (e.g., the customer drinks beer, smokes cigars, etc.), personal characteristics of the customer (e.g., the customer is bald, has a physical disability, etc.), age, sex, marital status, political affiliation, occupation, nationality, ethnicity, culture, location, residence, etc.

According to some embodiments of the present invention, advertising may be selected based upon advertising preferences of the customer. For example, it may be known that the customer likes automobile advertising or beer advertising. As such, automobile and/or beer advertising, or advertising related to such, is selected for this customer.

According to some embodiments of the present invention, advertising may be selected based upon advertising preferences of other customers that are similar to the requesting customer. For example, it may be known that the requesting customer is a movie fan and it may be known what types of advertising other movie fans desire to see. As such, advertising delivered to other customers who are movie fans may be selected and delivered to this customer. Furthermore, the customer may have requested a particular movie to be provided. Advertising delivered to other customers requesting this movie may be selected and provided to this customer.

According to some embodiments of the present invention, advertising may be selected based upon identifying a customer group to which the requesting customer belongs. For example, the customer may be a member of a group of customers that request science fiction-oriented content. As such, advertising targeted to the identified customer group (i.e., the science fiction-oriented content group) is selected and delivered to the requesting customer.

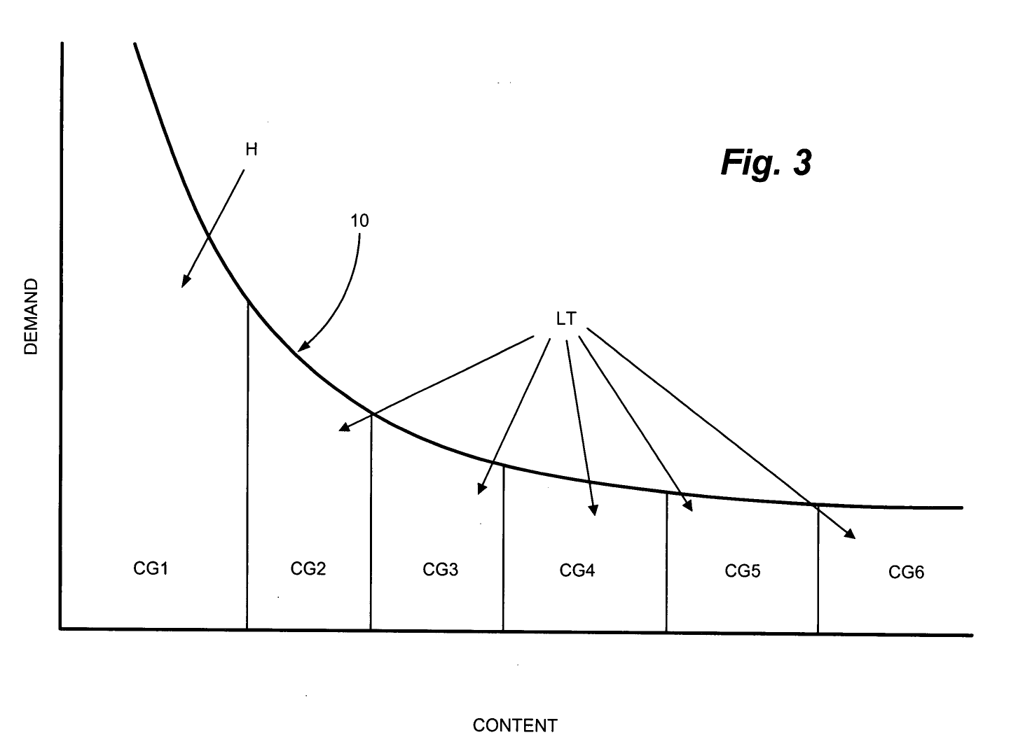

According to some embodiments of the present invention, advertising may be selected for delivery to a requesting customer by determining a position of the requested content on a content demand curve, and then selecting advertising that is associated with a content group at the position of the requested content on the content demand curve. For example, referring to FIG. 3, a content demand curve 10 is divided into a plurality of discrete content groups CG1-CG6. Content group CG1 contains head-of-tail content H and content groups CG2-CG6 contain long tail content LT, as described above. Advertising is associated with each content group CG1-CG6. Thus, when a customer requests content, it is initially determined what content group the content is located in, and then advertising associated with the content group is selected.

Referring back to FIG. 2, once advertising has been selected, the requested content and selected advertising are delivered to the requesting customer (Block 130). Content may be supplied by the service provider and/or by a third party content provider. Head-of-tail content typically is hosted by the service provider, though it need not be. As described above, head-of-tail content is traditionally content that is most in demand (i.e., “hits” which traditionally have dominated industry sales).

If the requested content is long tail content maintained by a third party, the content is obtained from the third party. Long tail content traditionally is content that is less often in demand (i.e., “non-hits”, or “niche content”). For example, movies produced by Hollywood studios would likely be classified as head-of-tail content, while eclectic movies produced by lesser known studios would likely be classified as long tail content. Obtaining content from a third party may include receiving the content from the third party or directing the third party to deliver the content to the customer directly.

Similarly, selected advertising may be provided directly from the service provider and/or may be obtained from a third party.

Exemplary content and advertising delivery methods include, but are not limited to, multicast and unicast. As known to those skilled in the art, multicast content is broadcast or streamed to a set of interested receivers according to a common schedule. For example, a television show is streamed at 7:00 pm and customers “tune in” to the stream by selecting to join a multicast group. Also, as known to those skilled in the art, unicast content is broadcast or streamed to a single receiver and does not require a common schedule.

Additional content delivery mechanisms that can be utilized in accordance with embodiments of the present invention include “buffer and play,” “download and play,” and “prepositioning”, each of which is well understood by those skilled in the art of the present invention. Each of these content delivery mechanisms can be implemented via analog or digital communications technologies.

As known to those skilled in the art, “pay-per-view” enables a customer to order and view content (e.g., movies and events) on an individual basis. In pay-per-view, a customer pays to view the content one time.

Still referring to FIG. 2, feedback is then obtained from the customer regarding the selected advertising (Block 140). Feedback includes, for example, information as to whether the customer liked the advertising or not, whether the customer would prefer other types of advertising, etc. In addition, obtaining feedback may also include allowing the customer to request delivery of alternative advertising. The obtained feed back is then used to build (e.g., create and/or modify) a customer preference knowledge base for use in selecting advertising to be delivered to this customer with subsequently requested content (Block 150).

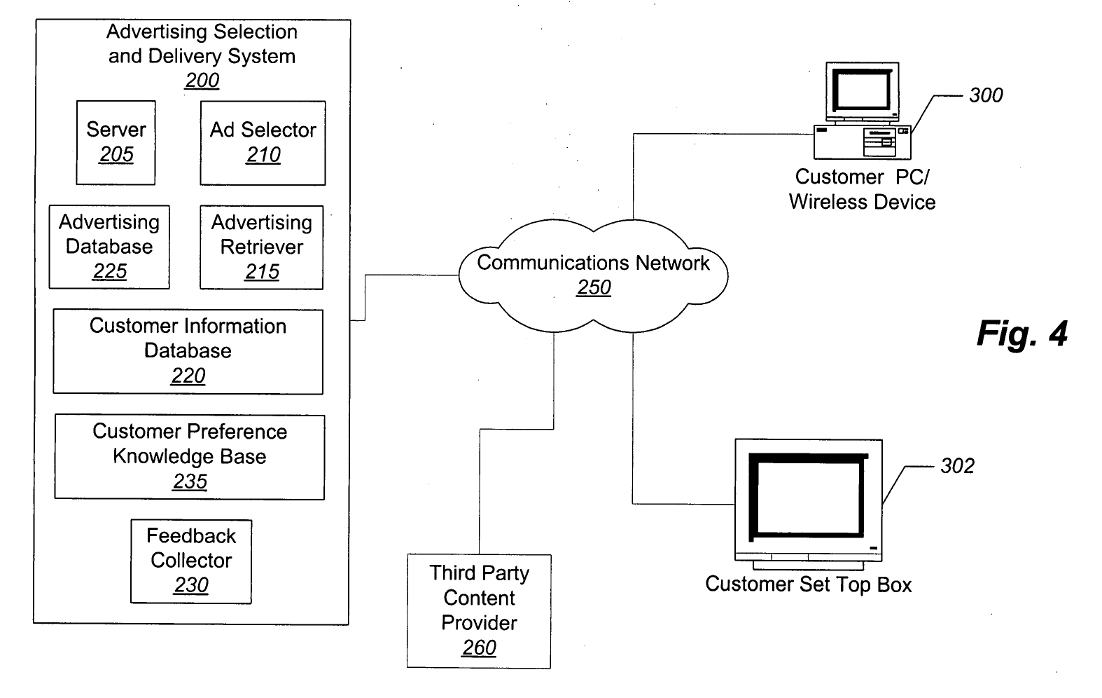

Referring to FIG. 4, an advertising selection and delivery system 200 for selecting and delivering advertising to customers requesting content from a service provider, according to some embodiments of the present invention, is illustrated. The illustrated advertising selection and delivery system 200 includes a server 205 that is configured to receive requests for content from customers and deliver requested content and selected advertising via a communications network 250. The illustrated advertising selection and delivery system 200 also includes an ad selector 210 that is configured to select advertising to be delivered with content requested by a customer and an advertising retriever 215 that is configured to retrieve advertising for delivery to a customer.

The ad selector 210 may be configured to select advertising in one or more various ways. For example, according to some embodiments of the present invention, the ad selector 210 may be configured to select advertising based upon information about the customer. This may include information obtained from the customer and/or information already known about the customer and maintained within a customer information database 220 and/or information obtained from a third party. Exemplary information includes, but is not limited to, information such as the customer's likes and dislikes, the customer's habits, personal characteristics of the customer, as described above. In addition, the ad selector 210 may be configured to select advertising based upon advertising preferences of other customers that are similar to the customer. The advertising retriever 215 is configured to retrieve selected advertising from an advertising database 225 and/or from a third party, etc. The ad selector 210 may also be configured to utilize content-related information, such as the position of content on a content demand curve, to select advertising. As such, the ad selector 210 may be capable of communicating with a content database and other interfaces associated with content selection and content placement on a content demand curve. The ad selector 210 may use content-related information solely or in combination with customer information.

The illustrated advertising selection and delivery system 200 also includes a customer information database 220 that maintains information about customers of the service provider.

The illustrated advertising selection and delivery system 200 also includes a feedback collector 230 that is configured to obtain feedback from customers regarding selected advertising delivered to them. In addition, the illustrated advertising selection and delivery system 200 includes a customer preference knowledge base that is in communication with the feedback collector 230 and ad selector 210 for use in selecting advertising to be delivered with subsequently requested content.

The communications network 250 may represent a global network, such as the Internet, or other publicly accessible network. The communications network 250 may also, however, represent a wide area network, a local area network, an Intranet, or other private network, which may not accessible by the general public. Furthermore, the communications network 250 may represent a combination of public and private networks or a virtual private network (VPN). The communications network 250 may also contain transmissions over-the-air or through a dedicated distribution network. The communications network 250 may also be wireless or wireline, or may include wireless and wireline portions.

In operation, a user, via a device, such as a computing device 300 or set top box 302, connected to the communications network 250, sends a request for content to a service provider. The request is received by the server 205 of the advertising selection and delivery system 200. The advertising selector 210 selects advertising to be delivered to the requesting customer with the requested content. The advertising retriever 215 retrieves the selected advertising, for example, from an advertising database 225 and/or from a third party. The selected advertising is delivered to the customer along with the requested content. Subsequently, feedback from the customer is obtained via the feedback collector 230 regarding the customer's satisfaction with the delivered advertising. The feedback collector 230 updates the customer preference knowledge base 235 with obtained customer feedback.

Although FIG. 4 illustrates an exemplary advertising selection and delivery system for selecting and delivering advertising to customers of a service provider, it will be understood that the present invention is not limited to such configurations, but is intended to encompass any configuration capable of carrying out the operations described herein.

FIGS. 2 and 4 illustrate the architecture, functionality, and operations of some embodiments of methods, systems, and computer program products for selecting and delivering advertising to customers of a service provider. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved. In addition, functions of the customer preference knowledge base 235 and customer information database 220 may be performed by separate databases or by a single database. Moreover, one or more databases performing the functions of the customer preference knowledge base 235 and customer information database 220 may be located locally or remotely, as would be understood by one skilled in the art.

Many variations and modifications can be made to the preferred embodiments without substantially departing from the principles of the present invention. All such variations and modifications are intended to be included herein within the scope of the present invention, as set forth in the following claims.

That which is claimed:

1. A method of targeting advertising to customers requesting content from a service provider, comprising:
receiving a request for content from a customer;
selecting advertising to be delivered with the requested content;
delivering the requested content and selected advertising to the customer;
obtaining feedback from the customer regarding the selected advertising; and
building a customer preference knowledge base for use in selecting advertising to be delivered with subsequently requested content.

2. The method of claim 1, wherein the customer request is generated in whole or in part via a set top box.

3. The method of claim 1, wherein the customer request is generated in whole or in part via a web site.

4. The method of claim 1, wherein content comprises audio content, video content, text content, gaming content, interactive content, and/or application content.

5. The method of claim 1, wherein selecting advertising to be delivered with the requested content comprises selecting advertising based upon information about the customer.

6. The method of claim 1, wherein selecting advertising to be delivered with the requested content comprises selecting advertising based upon advertising preferences of the customer.

7. The method of claim 1, wherein selecting advertising to be delivered with the requested content comprises selecting advertising based upon advertising preferences of other customers that are similar to the customer.

8. The method of claim 1, wherein selecting advertising to be delivered with the requested content comprises identifying a customer group that the customer is a member of and selecting advertising targeted to the identified customer group.

9. The method of claim 1, wherein selecting advertising to be delivered with the requested content comprises:
determining a position of the requested content on a content demand curve, wherein the content demand curve is divided into a plurality of discrete content groups, and wherein advertising is associated with each content group; and
selecting advertising that is associated with a content group at the position of the requested content on the content demand curve.

10. The method of claim 1, wherein delivering advertising comprises obtaining the selected advertising from a third party.

11. The method of claim 1, wherein obtaining feedback from the customer comprises one or more of the following: allowing the customer to request delivery of alternative advertising, allowing the customer to indicate whether or not they like or dislike the delivered advertising, and allowing the customer to indicate preferred advertising type.

12. A computer program product for targeting advertising to customers requesting content from a service provider, comprising:
a computer readable storage medium having computer readable program code embodied therein, the computer readable program code being configured to carry out the method of claim 1.

13. A method of targeting advertising to customers requesting content from a service provider, comprising:
receiving a request for content from a customer;
selecting advertising to be delivered with the requested content;
delivering the requested content and selected advertising to the customer; and
obtaining feedback from the customer regarding the selected advertising, including allowing the customer to request delivery of alternative advertising.

14. The method of claim 13, wherein selecting advertising to be delivered with the requested content comprises selecting advertising based upon one or more of the following: information about the customer, advertising preferences of the customer, and/or advertising preferences of other customers that are similar to the customer.

15. The method of claim 13, wherein selecting advertising to be delivered with the requested content comprises identifying a customer group that the customer is a member of and selecting advertising targeted to the identified customer group.

16. The method of claim 13, wherein selecting advertising to be delivered with the requested content comprises:
determining a position of the requested content on a content demand curve, wherein the content demand curve is divided into a plurality of discrete content groups, and wherein advertising is associated with each content group; and
selecting advertising that is associated with a content group at the position of the requested content on the content demand curve.

17. A computer program product for targeting advertising to customers requesting content from a service provider, comprising:
a computer readable storage medium having computer readable program code embodied therein, the computer readable program code being configured to carry out the method of claim 13.

18. A system for targeting advertising to customers requesting content from a service provider, comprising:
a server that receives a request for content from a customer;
an ad selector that selects advertising to be delivered with the requested content;
a feedback collector that obtains feedback from the customer regarding the selected advertising; and
a customer preference knowledgebase in communication with the feedback collector and ad selector for use in selecting advertising to be delivered with subsequently requested content;
wherein the server is configured to deliver the requested content and selected advertising to the customer.

19. The system of claim 18, further comprising an ad database from which the ad selector selects advertising.

20. The system of claim 18, wherein the ad selector is configured to select advertising based upon one or more of the following: information about the customer, advertising preferences of the customer, and/or advertising preferences of other customers that are similar to the customer.
